(19) United States
(12) Patent Application Publication
(10) Pub. No.: US 2026/0093758 A1
(43) Pub. Date: Apr. 2, 2026

(54) DATA PROCESSING METHOD AND ELECTRONIC DEVICE

(71) Applicant: Lenovo (Beijing) Limited, Beijing (CN)

(72) Inventors: Jingwei SUN, Beijing (CN); Gang MA, Beijing (CN); Meng WU, Beijing (CN)

(21) Appl. No.: 19/333,177

(22) Filed: Sep. 18, 2025

(30) Foreign Application Priority Data
Sep. 27, 2024 (CN) 202411367772.9

(51) Int. Cl. G06F 16/906

(52) U.S. Cl. CPC G06F 16/906

(57) ABSTRACT

A data processing method includes determining a user task based on interactive information of a user, and determining, based on the user task, at least one piece of target data from a plurality of pieces of data included in a data set of the user. The plurality pieces of data are determined based on historical cross-device multimodal historical interactive information related to the user and include prediction task information. The method further includes performing aggregation processing on the at least one piece of target data to obtain an aggregation processing result, and generating a target processing result corresponding to the user task based on the aggregation processing result.

### CROSS-REFERENCE TO RELATED APPLICATION

This application claims priority to Chinese Patent Application No. 202411367772.9, filed on Sep. 27, 2024, the entire content of which is incorporated herein by reference.

### TECHNICAL FIELD

The present disclosure generally relates to the field of computer technologies and, more particularly, to a data processing method and an electronic device.

### BACKGROUND

In daily study and work, a user needs to refer to previously browsed information to assist in solving a current task. However, the information that the user previously browsed is often scattered across various electronic devices, and it is even more difficult to uniformly organize the information scattered across various electronic devices, making it difficult for the user to efficiently use the information. Therefore, how to effectively organize and use historical information related to the user has become an urgent problem to be solved.

### SUMMARY

In accordance with the disclosure, there is provided a data processing method including determining a user task based on interactive information of a user, and determining, based on the user task, at least one piece of target data from a plurality of pieces of data included in a data set of the user. The plurality pieces of data are determined based on historical cross-device multimodal historical interactive information related to the user and include prediction task information. The method further includes performing aggregation processing on the at least one piece of target data to obtain an aggregation processing result, and generating a target processing result corresponding to the user task based on the aggregation processing result.

Also in accordance with the disclosure, there is provided an electronic device including a memory storing instructions, and a processor configured to execute the instructions to determine a user task based on interactive information of a user, and determine, based on the user task, at least one piece of target data from a plurality of pieces of data included in a data set of the user. The plurality pieces of data are determined based on historical cross-device multimodal historical interactive information related to the user and include prediction task information. The processor is further configured to execute the instructions to perform aggregation processing on the at least one piece of target data to obtain an aggregation processing result, and generate a target processing result corresponding to the user task based on the aggregation processing result.

Also in accordance with the disclosure, there is provided a data processing method including performing semantic analysis on interactive information of a user to obtain at least one piece of data. The interactive information represents cross-device multimodal interactive information related to the user. The method further includes predicting, based on the at least one piece of data, at least one prediction task corresponding to the at least one piece of data, storing the at least one prediction task in association with corresponding data, and performing clustering processing on the at least one piece of data to obtain a data set of the user.

### BRIEF DESCRIPTION OF THE DRAWINGS

To more clearly illustrate the technical solutions of the embodiments of the present disclosure, the drawings needed for use in the description of the embodiments will be briefly introduced below. The drawings described below are some embodiments of the present disclosure. For those of ordinary skill in the art, other drawings can be obtained according to these drawings without any creative work.

FIG. 1 is a flow chart of a data processing method consistent with embodiments of the present disclosure.

FIG. 2 is a flow chart of another data processing method consistent with embodiments of the present disclosure.

FIG. 3 is a flow chart showing using a data processing method to perform task processing consistent with embodiments of the present disclosure.

FIG. 4 is a schematic diagram showing a target processing result generated by a data processing method consistent with embodiments of the present disclosure.

FIG. 5 is a schematic diagram showing a task panel realized through a data processing method consistent with embodiments of the present disclosure.

FIG. 6 is a flow chart showing using a data processing method to generate a data set consistent with embodiments of the present disclosure.

FIG. 7 is a schematic hardware diagram of an electronic device consistent with embodiments of the present disclosure.

FIG. 8 is a schematic hardware diagram of another electronic device consistent with embodiments of the present disclosure.

### DETAILED DESCRIPTION OF THE EMBODIMENTS

Various schemes and features of the present disclosure are described herein with reference to the accompanying drawings. It should be understood that various modifications may be made to the embodiments of the present disclosure. Therefore, the description should not be regarded as limiting, but only as examples of the embodiments. Based on the embodiments in the present disclosure, all other embodiments obtained by those skilled in the art without creative work are within the scope of the present disclosure.

In the following description, this specification may use the phrases “in one embodiment,” “in another embodiment,” or “in some embodiments,” which may describe a subset of all possible embodiments, but it is understood that “some embodiments” can be the same subset or different subsets of all possible embodiments, and can be combined with each other without conflict.

The terms “first/second/third” are only used to distinguish similar objects, and do not represent a specific order for the objects. It is understood that objects described in connection with “first/second/third” can be in any order or sequence where permitted, such that the embodiments of the present disclosure described here can be implemented in an order other than that illustrated or described here.

Unless otherwise defined, all technical and scientific terms used in the present disclosure have the same meaning as those generally understood by those skilled in the art. The terms used in the present disclosure are only for the purpose of description and are not intended to limit the scope of the present disclosure.

In daily life, a user is exposed to various types of information, which are scattered across different devices and applications, such as mobile devices, personal computers (PCs), cloud disks, news applications, social applications, etc.

Because the information is scattered across different devices and applications, it is difficult to uniformly manage and efficiently use it, which makes it difficult for the user to quickly find the required information when they need to use it. For example, when the user works on a task, he needs to switch back and forth between different devices and applications, and spend a lot of time and energy to find and organize relevant information, which affects the entry into an efficient flow state.

In addition, even if the user consciously organizes and manages the information, he usually searches for information through folders or tags. However, because of the complex network relationship between various types of information, the additional data generated in the organization and management process may far exceed the original hierarchical structure or tag system, making effective management extremely challenging.

In the process of performing retrieval on historical information, the user needs to extract useful content from a large amount of information (for example, reference materials, web links, chat records, etc.). What's worse is that the user may not even remember that he has noticed certain information and cannot come up with accurate keywords to search for it. Therefore, he cannot actively find the required content. In this case, the efficiency of information utilization is greatly reduced.

To solve the above technical problems, various solutions have been proposed.

For example, the information on various devices related to the user is synchronized to a cloud server to achieve unified storage of historical information.

As another example, multi-device synchronization tools are used to synchronize the information on various devices related to the user to one same device to achieve data synchronization across devices.

As a further example, information management and organization functions are provided through applications, and then different types of information are aggregated for management.

However, the above solutions still require the user to actively store, manage and search for information, which requires high information management capabilities (including time requirements and capability requirements) from the user, and it is difficult to effectively manage fragmented information. Therefore, for users, there is still a problem of low information utilization efficiency.

The present disclosure provides a data processing method, which can be executed by a processor of an electronic device, to at least partially alleviate the above problems. The electronic device may be a server, a laptop, a tablet computer, a desktop computer, a smart TV, a TV box, a mobile device (such as a mobile phone, a portable video player, a personal digital assistant, a dedicated messaging device, or a portable gaming device) or another device with data processing capabilities.

In some embodiments, the data processing method provided by the present disclosure may be implemented as a cross-platform agent application. An agent may run on at least one device related to the user, such as the user's mobile phone, laptop, tablet computer, desktop computer, or cloud device storing user data. Further, the agent may have a cross-application data reading capability to read and analyze application data of different applications running on the electronic device. When the agent reads and analyzes application data of different applications running on the electronic device, it may need to obtain user authorization.

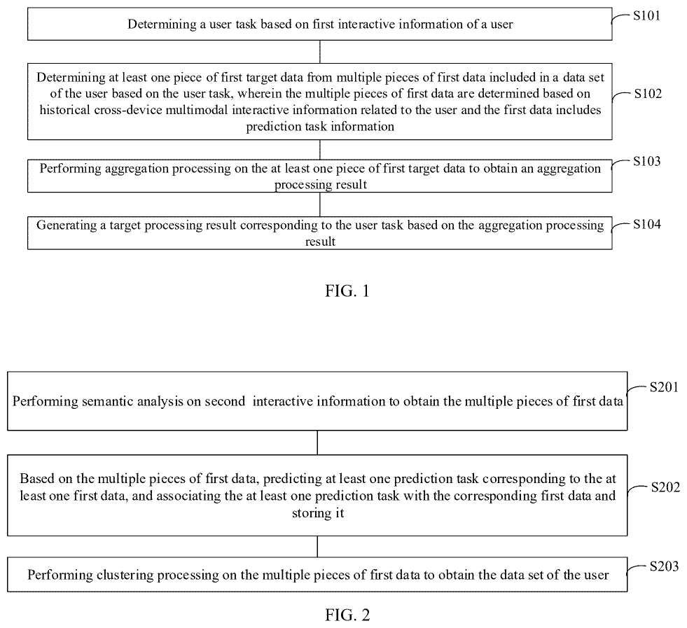

In one embodiment shown in FIG. 1, which is a flow chart of a data processing method provided by the present embodiment, the data processing method includes S101 to S104.

At S101, based on first interactive information of a user, a user task is determined.

The first interactive information may be information determined based on a current interactive action of the user.

In some embodiments, the first interactive information may include multimodal information. For example, the first interactive information may include text information, image information, audio information, video information, user operation information, and the like.

In some embodiments, the first interactive information may be information obtained from different devices. For example, the first interactive information may be information obtained from an electronic device currently used by the user, or may be information obtained from a cloud device for storing interactive information related to the user.

Determining the user task based on the first interactive information may include determining a task that the user expects to solve by performing text recognition, object recognition, semantic analysis, and the like, on the first interactive information.

In some embodiments, when using an agent to implement the data processing method provided by the present disclosure, the agent may use a multimodal large model to process the first interactive information to determine the user task. For example, when the first interactive information includes text information and image information, the multimodal large model may be used to perform semantic extraction on the text information and image information, and the corresponding user task may be determined based on the extracted semantic information.

In some embodiments, the multimodal large model may include a multimodal large language model.

At S102, based on the user task, at least one piece of first target data is determined from multiple pieces of first data included in a data set of the user, where the multiple pieces of first data are determined based on historical interactive information of cross-device multimodality related to the user, and the multiple pieces of first data include prediction task information.

The historical interactive information of cross-device multimodality may be historical interactive information of multimodality obtained from multiple devices.

In some embodiments, the multiple devices may include the user's electronic devices, such as the user's mobile phone, tablet computer, laptop computer, desktop computer, camera, mobile hard disk, etc., and may also include electronic devices storing information related to the user, such as a cloud disk, etc.

In some embodiments, the information of multimodality may include text information, image information, audio information, video information, information read from news applications or social applications, etc.

Therefore, the multiple pieces of first data may be obtained by analyzing and processing the historical interactive information of cross-device multimodality related to the user. Based on the multiple pieces of first data, a data set of the user may be established.

In some embodiments, the data set may be a vector database obtained after vectorization processing and semantic analysis of the historical interactive information of cross-device multimodality.

In some embodiments, the data set may be a user's personal knowledge base (PKB) or a retrieval-augmented generation (RAG) database used for RAG technology.

The prediction task information may be task information corresponding to the multiple pieces of first data determined based on the page or user operation corresponding to the multiple pieces of first data.

In some embodiments, the multiple pieces of first data may include one or more pieces of prediction task information.

In the data set, the multiple pieces of first data and at least one piece of prediction task information related thereto may be associated and stored. Therefore, when performing data retrieval, the relevance of the multiple pieces of first data to the retrieval information may be determined based on the prediction task information.

In some embodiments, determining the at least one piece of first target data from the data set based on the user task may include performing retrieval on the user's data set based on the semantic information included in the user task to determine the at least one piece of first target data closest to the semantic information of the user task from the multiple pieces of first data.

At S103, aggregation processing is performed on the at least one piece of first target data to obtain an aggregation processing result.

Performing the aggregation processing on the at least one piece of first target data may include extracting information related to the user task from the at least one piece of first target data and organizing the extracted information into a logical aggregation processing result.

In some embodiments, after determining the at least one piece of first target data from the user data set, the agent may perform the aggregation processing on the at least one piece of first target data using a large model.

At S104, based on the aggregation processing result, a target processing result corresponding to the user task is generated.

The target processing result may be a processing result to be presented to the user.

In some embodiments, the target processing result may include a picture generation result, a text generation result, a knowledge tree generation result, a voice generation result, etc., related to the user task, which is to be presented to the user.

In some embodiments, based on the aggregation processing result, the agent may generate the corresponding target processing result using a large model.

In some embodiments, the data processing method may further include determining a task scenario corresponding to the user task and determining a display form of the target processing result based on the task scenario.

In some embodiments, based on the task scenario, a user interface (UI) component suitable for displaying information may be called to generate the target processing result.

For example, when the task scenario corresponding to the user task is a meeting scenario, the target processing result may include at least a summary answer corresponding to the user task and a source file link corresponding to the summary answer, such as a web page link, image link, folder link, etc., which is related to the answer.

As another example, when the task scenario corresponding to the user task is a paper reading scenario, the target processing result may include a knowledge tree generated based on the retrieval results, where the knowledge tree includes knowledge points of various levels related to the user task and corresponding source file links.

In the data processing method provided by the present disclosure, based on the user's first interactive information, the user task may be determined. Based on the user task, the at least one piece of first target data may be determined from the multiple pieces of first data included in the user's data set, where the multiple pieces of first data are determined based on the historical interactive information of cross-device multimodality related to the user and include the prediction task information. The aggregation processing may be performed on the at least one piece of first target data to obtain the aggregation processing result. Based on the aggregation processing result, the target processing result corresponding to the user task may be generated. Therefore, the user task may be extracted from the user's interactive information and the corresponding target processing result may be generated, making the identification and processing of the user task more intelligent. Further, the user's data set may be generated based on the user's cross-device multimodal data to generate the target processing result corresponding to the user task, realizing the connection of all-scenario user data, cross-device cross-modal search, and application of personal data. Also, the multiple pieces of first data in the user's data set may have the corresponding prediction task information, realizing the task-centered organization and management of the user's cross-device multimodal data, thereby making the retrieval process of the user's data set more accurate and efficient, and improving the utilization and management efficiency of user data.

In some embodiments, the first interactive information may include at least one of: user input information determined based on the user's input operation or cross-device multimodal application interactive information related to the user.

The user's input operation may be an input operation of the user in a specified application. The user input information may be information based on the user's input in the specified application.

The specified application may be an application used to implement the data processing method provided in the present disclosure, such as an agent.

The cross-device multimodal application interactive information may be multimodal information obtained from multiple devices related to the user, such as chat content information between the user and an interacting party obtained from a social application running on the user's mobile phone, web page information browsed by the user obtained from a web application running on the user's tablet computer, user selection information of part of the content in the current browsing page obtained from the user's personal computer; and so on.

In some embodiments, the cross-device multimodal application interactive information related to the user may be obtained through the agent. Therefore, the agent may be a system-level application running on an electronic device that is able to obtain the multimodal information across devices and applications.

In one embodiment, determining the user task based on the first interactive information of the user (S101) may be implemented as at least one of S1011 or S1012.

At S1011, based on the user input information, the user task is determined.

The user input information may be semantically understood and the corresponding user task may be determined.

In some embodiments, first, the user input information may be vectorized using a multimodal large model to obtain a corresponding vector representation. Then, the vector representation of the user input information may be semantically extracted using the large model to obtain the corresponding semantic information. Finally, the large model may be used to determine the user task based on the extracted semantic information.

At S1012, based on the application interactive information, the user task is determined.

The obtained cross-device multimodal application interactive information may be semantically understood and the corresponding user task may be determined.

In some embodiments, first, information may be extracted from the cross-device multimodal information to obtain corresponding information details. For example, text information, icon information, function key operation information, voice information, etc., may be extracted. Then, the extracted information details may be vectorized using a large model to obtain corresponding vector representations. Subsequently, semantic extraction may be performed on the vector representations corresponding to the application interactive information using a large model, to obtain corresponding semantic information. Finally, the user task may be determined based on the extracted semantic information using the large model.

In the above embodiments, the user task may be passively obtained based on the user input information. In some other embodiments, the user task may also be actively determined by collecting and analyzing the cross-device multimodal application interactive information related to the use. Multiple user task determination methods may be provided. Therefore, in the user interactive process, in response to the user input or the other application interactive information, response information for related tasks may be provided to the user passively or actively, thereby improving the flexibility and intelligence of human-computer interactive, and thus improving the user's experience.

In some embodiments, determining the user task based on the user's first interactive information (S101) may further include S1013 and S1014.

At S1013, based on the first interactive information, at least one piece of second target data related to the first interactive information is determined from the multiple pieces of first data.

According to the currently obtained first interactive information, retrieval may be performed on the user's historical interactive information to determine at least one historical interactive information related to the first interactive information.

In some embodiments, first, the first interactive information may be vectorized to obtain the corresponding vector representation. Then, the vector representation corresponding to the first interactive information may be semantically analyzed to obtain the corresponding semantic information. Subsequently, based on the semantic information corresponding to the first interactive information, retrieval may be performed on the user's historical interactive information. That is, retrieval may be performed on the data set including the multiple pieces of first data to obtain the at least one piece of second target data related to the first interactive information.

For example, when the first interactive information is “send a team building picture email to the management department” input by the user, after semantic analysis of the first interactive information, at least key semantic information including “management department,” “team building picture,” “send to the management department,” and “email” may be determined. Then, based on the determined semantic information, retrieval may be performed on the data set, and specific management department information related to the team building may be determined from multiple management departments, and the team building currently specified by the user may be determined from multiple pieces of team building information, etc.

At S1014, based on the first interactive information and the at least one piece of second target data, the user task is determined.

After determining the at least one piece of second target data related to the first interactive information, the content of the first interactive information may be further enriched in combination with the at least one piece of second target data, to more accurately describe the user task.

For example, in the above case, based on the determined at least one piece of second target data and the first interactive information, it may be determined that the user task to be described by the user is “send an email of the most recent team building picture to the human resources department. ”

Therefore, by combining the user's historical interactive information and further understanding the current first interactive information, the user's intention may be understood more accurately, and the user task that is more in line with the user's original intention may be generated, thereby providing a more accurate target processing result.

In some embodiments, determining the user task based on the first interactive information of the user (S101) may include S1015 to S1017.

At S1015, application scenario information corresponding to the first interactive information and historical operation information of the user are obtained.

The application scenario information may be multimodal information collected from at least one device when obtaining the first interactive information.

In some embodiments, the application scenario information may be obtained by performing screenshot processing on devices related to the user, reading the interactive information of the user in the specified application, etc.

The historical operation information may include interactive habits, preferences or other information of the user determined based on the user interactive information collected within a specified time period in the past, such as information of the user's click frequency on news applications, the user's reading time and frequency of picture information are higher than that of text information, the user preference to set the alarm after 20 o'clock every night, and so on.

In some embodiments, the historical operation information may be pre-stored in a user information library of the user.

At S1016, based on the application scenario information and the historical operation information, context information corresponding to the first interactive information is determined.

The context information may be task background information related to the user task included in the first interactive information, such as task scenario information, task context information, and the like. The context information may assist in understanding the user task.

In some embodiments, the task scenario information may include email scenarios, meeting scenarios, reading scenarios, project planning scenarios, and the like.

In some embodiments, the obtained application scenario information and the historical operation information may be processed using a multimodal large model to determine the context information corresponding to the first interactive information.

For example, in the case where the application scenario information is a screenshot image captured using an agent, the screenshot image may be processed by a multimodal large model for target recognition or text recognition to determine the task scenario corresponding to the current task. As another example, in the case where the screenshot image contains an email icon, the task scenario may be determined to be an email scenario. As a further example, in the case where the application scenario information is text information in a document read by an agent, the task scenario may be determined to be a report reading scenario. As a further example, by identifying the text information in the document, the text context information corresponding to the part of the text selected by the user in the document may be determined; and so on.

As another example, the user's preference for reading image information may be used as the context information, to determine that the user task at least includes a task for searching for related images.

At S1017, based on the context information and the first interactive information, the user task is determined.

In some embodiments, the context information and the first interactive information may be input into a large model to determine the user task using the large model.

The large model may use the context information to assist in understanding the user task included in the first interactive information, such that the large model is able to understand the user's intention more accurately.

In the above embodiments, by capturing the application scenario information related to the first interactive information and obtaining the user's historical habit information, the context information corresponding to the first interactive information may be determined. The context information may be used to more accurately understand the user task that the user expects to establish through the first interactive information. Therefore, the target processing result that is more in line with the user's expectations may be provided, thereby improving the intelligence of the agent in the human-computer interactive process.

In some embodiments, determining at least one piece of first target data from the multiple pieces of first data included in the user's data set based on the user task (S102) may include:
S1021: based on the user task, retrieval is performed on the multiple pieces of first data to determine the at least one piece of first target data; where the retrieval at least includes performing retrieval on the multiple pieces of first data based on the prediction task information of the user task corresponding to each of the first data.

In some embodiments, the data set may be in the form of a database. Thus, after determining the user task, the user task may be sent to the data set to perform retrieval on the multiple pieces of first data using a database retrieval function and determine the at least one piece of first target data.

In some embodiments, the retrieval process of the multiple pieces of first data may be implemented by clustering processing.

In some embodiments, the multiple pieces of first data in the data set may be vectorized representations obtained by vectorizing the multimodal historical information related to the user across devices using a large model, and the user task may also be a vectorized representation obtained after vectorization processing. Therefore, retrieval may be performed on the multiple pieces of first data, that is, the at least one piece of first target data closest to the vector representation of the user task may be determined from the multiple pieces of first data.

In some other embodiments, the multiple pieces of first data in the data set may be vector representations determined based on the user's cross-device multimodal information, and have corresponding semantic information. Therefore, the at least one piece of first target data may be determined based on the semantic similarity between the multiple pieces of first data and the user task.

In some embodiments, in the process of performing retrieval on the user's data set, a global retrieval may be performed on the data set.

The retrieval may be performed at least based on the prediction task information corresponding to the user task and each piece of first data, that is, the prediction task information corresponding to the first data may be used as a retrieval condition to determine the similarity between each piece of first data and the user task.

Since the prediction task information is able to represent at least one task related to the first data, therefore, performing the retrieval on the first data based on the prediction task information may determine the relevance of the multiple pieces of first data and the user task from the perspective of the task corresponding to each piece of first data, thereby improving the retrieval accuracy and efficiency.

In some embodiments, the data processing may further include S105 to S107 before determining the at least one piece of first target data from the multiple pieces of first data included in the user's data set based on the user task (S102).

At S105, semantic analysis is performed on the historical interactive information to obtain at least one piece of first data.

As described above, historical interactive information may be the multimodal information obtained from multiple devices, such as, image information, text information, application interactive information, etc., obtained from devices such as the user's mobile phone, laptop, desktop computer, tablet computer, or cloud disk for storing user data.

In some embodiments, shallow information extraction may be performed on the historical interactive information to identify text information, UI elements, etc., in the historical interactive information.

After shallow information extraction is performed on the historical interactive information, vectorization processing may be performed on the extracted information to obtain corresponding vectorized representation information.

In some embodiments, vectorization processing may be performed on the information obtained after shallow information extraction using a large model.

In some embodiments, semantic analysis may be performed on the vectorized representation information using a large model to map cross-device multimodal information to the same semantic space to obtain the at least one piece of first data with semantic features.

In some embodiments, performing semantic analysis on the vectorized representation information of the historical interactive information may include: determining at least one entity information or at least one concept information from the vectorized representation information, and determining relationship information between entities or concepts, etc. For example, information such as appointment, place name, time, and the association relationship between these entity information, may be determined.

At S106, based on the at least one piece of first data, at least one prediction task corresponding to the at least one piece of first data is predicted, and the at least one prediction task is stored in association with corresponding first data.

Task prediction may be performed on the at least one piece of first data to determine the at least one prediction task corresponding to the at least one piece of first data.

In some embodiments, based on the semantic information corresponding to the at least one piece of first data, the task information involved in the current page or user operation corresponding to the at least one piece of first data may be determined using a large model. For example, based on the current text interactive content of the user and the UI interface elements extracted from the page, the prediction task corresponding to the current text interactive content may be determined.

In some embodiments, the first data may correspond to one or more prediction tasks.

For example, when the first data is entity information “calendar,” “calendar” may be related to the meeting appointment task in the meeting scenario, “calendar” may be related to the task of setting reminders in the family scenario, or “calendar” may be related to the task of sending emails at a scheduled time in the email scenario, and so on. Therefore, tasks such as “meeting appointment,” “setting reminders,” or “sending emails at a scheduled time” may all be set as prediction tasks corresponding to “calendar. ”

Also, the at least one prediction task may be stored in association with the corresponding first data, such that a more accurate retrieval result may be obtained based on the at least one prediction task when performing a search on the data set.

At S107, clustering processing is performed on the at least one piece of first data to obtain the data set of the user.

The clustering processing may be performed on at least one piece of first data to establish an association relationship between different historical interactive information and realize structured processing of the multiple pieces of first data.

In some embodiments, the clustering processing may be performed on the at least one piece of first data based on any clustering algorithm in the art, such as k-means clustering algorithm (k-means algorithm), mean shift clustering algorithm (Mean shift), density-based spatial clustering of applications with noise (DBSCAN), or expectation maximization (EM) clustering algorithm based on Gaussian mixture model (GMM).

In some embodiments, the clustering processing may be performed on the at least one piece of first data to obtain a clustering result of a tree structure.

In some embodiments, a corresponding multimodal file index may be generated for the multiple pieces of first data in the data set, to perform retrieval of the multiple pieces of first data based on the multimodal file index.

In the above embodiments, by mapping the historical interactive information of cross-device multimodality to the same semantic space, the at least one piece of first data may be obtained and the at least one prediction task corresponding to the at least one piece of first data may be predicted. Then, the clustering processing may be performed on the at least one piece of first data, and the user's data set may be obtained, thereby realizing task-centric organization and management of the user's historical interactive information. Therefore, when performing data retrieval subsequently, retrieval may be performed on the multiple pieces of first data based on the at least one piece of prediction task information of the multiple pieces of first data, thereby improving retrieval efficiency and accuracy.

In some embodiments, the data processing method may further include at least one of S108 or S109.

At S108, the user's data set is updated based on the user task and the target processing result.

Since the target processing result is able to characterize the adjustment of the user's current interactive information to the historical interactive information, updating the data set based on the user task and the target processing result may learn the user's understanding of the knowledge structure and usage habits, and use it for the generation of subsequent user tasks.

In some embodiments, based on the user task and the target processing result, at least one entity information or at least one concept information, as well as the association relationship between the entity information or the concept information, may be determined. Then, the determined entity information or concept information and the association relationship information may be stored in the data set.

In some embodiments, based on the correspondence between the user task and the target processing result, the association relationship between the multiple pieces of first data stored in the data set may be adjusted or a new association relationship may be established between the multiple pieces of first data.

At S109, in response to a modification operation of the user on the target processing result, the target processing result is updated, and the user's data set is updated based on the user task and the updated target processing result.

The target processing result corresponding to the output user task may be displayed to allow the user to modify the target processing result.

In some embodiments, the output target processing result may be displayed in a pop-up window or sidebar or other location. The output target processing result may also be displayed in an interactive interface provided by the agent for executing the data processing method; and so on.

For example, when the output target processing result is displayed in the form of a knowledge tree, the user may be allowed to modify or adjust each node in the knowledge tree. When the output target processing result is displayed in the form of a picture, the user may be allowed to modify the brightness, color, display position of each object, and other information of the picture; and so on.

Therefore, in response to the user's modification operation, the target processing result may be updated to make the target processing result more in line with the user's expectations.

Also, the updated target processing result may more accurately reflect the user's expected processing results for the user task. Therefore, updating the user dataset based on the user task and the updated target processing result may make the user dataset more in line with the user's understanding of the knowledge structure, usage habits and preferences.

Another embodiment of the present disclosure also provides another data processing method, which may be executed by a processor of an electronic device. In some embodiments, the electronic device may be an edge device, such as a server set in a local area network. The electronic device may also be an end device with data processing capabilities, such as a laptop, a tablet computer, a desktop computer, etc.

As shown in FIG. 2, in some embodiments, the data processing method includes S201 to S203.

At S201, semantic analysis is performed on second interactive information of the user to obtain at least one piece of first data, where the second interactive information represents cross-device multimodal interactive information related to the user.

At S202, based on the at least one piece of first data, at least one prediction task corresponding to the at least one piece of first data is predicted and the at least one prediction task is stored in association with corresponding first data.

At S203, clustering processing is performed on the at least one piece of first data to obtain the user's data set.

The second interactive information may correspond to the historical interactive information in the above embodiments, and S201 to S203 may correspond to the above S105 to S107, respectively. Therefore, for the specific implementation of S201 to S203, references may be made to the detailed description of S105 to S107.

In the above embodiments, the electronic device implementing the above data processing method may uniformly obtain and organize the user's cross-device multimodal information, and organize and manage the information with the task as the center, thereby realizing the unified management of user data and improving the management efficiency of user data.

In some embodiments, the data processing method may further include at least one of S204 or S205.

At S204, based on third cross-device multimodal interactive information related to the user, the data set is updated.

After determining the data set based on the second interactive information, the third cross-device multimodal interactive information related to the user may be collected and semantic analysis may be performed on the third interactive information. Then, the user's data set may be updated based on semantic analysis results of the third interactive information.

In some embodiments, semantic analysis may be performed on the third interactive information to obtain at least one piece of second data. Then, based on at least one piece of first data and the at least one piece of second data stored in the data set, the at least one prediction task corresponding to the at least one piece of first data may be re-predicted, and at least one prediction task corresponding to at least one piece of second data may be predicted. Then, the first data and the at least one prediction task corresponding to the first data may be associated and stored, and the second data and the at least one prediction task corresponding to the second data may be associated and stored, to obtain an updated data set.

In some embodiments, clustering processing may be performed on the at least one piece of first data and the at least one piece of second data, that is, structural processing may be performed on the updated data set.

Therefore, by updating the user's data set through the third interactive information obtained after the second interactive information, the effect of real-time or periodic monitoring of the user's newly generated cross-device multimodal data and dynamic updating of the data set may be achieved.

At S205, in response to the user's update operation on the data set, the data set is updated.

The output data set of the user may be displayed to allow the user to update at least part of the data in the data set or the association relationship between the data.

In some embodiments, the output data set may be displayed in the form of a knowledge tree. For example, the multiple pieces of first data in the data set may be organized in the form of a tree diagram; and the multiple pieces of first data represented by vectorization may be visualized and output.

In some embodiments, the update operation may include a deletion operation, an insertion operation, a replacement operation, etc., of at least part of the data in the data set or the association relationship between the data, of the user.

Therefore, in response to the user's update operation, at least part of the data in the data set or the association relationship between the data may be updated, such that the user's data set may be more in line with the user's knowledge structure or behavior habits.

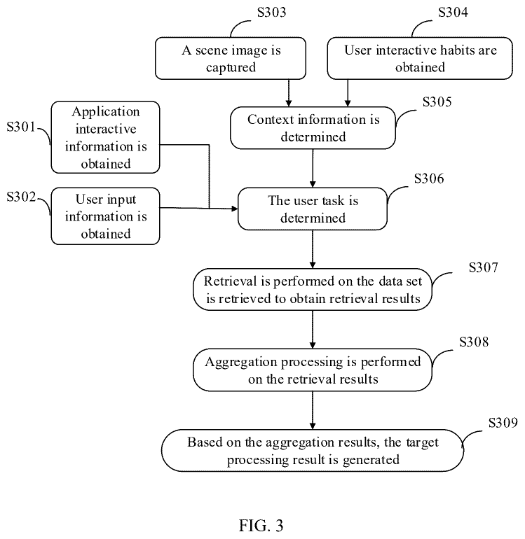

Below, in conjunction with FIG. 3, taking the use of an agent to implement the data processing method provided by the present disclosure as an example, the data processing method provided by the present disclosure is described in detail. As shown in FIG. 3, the embodiment includes S301 to S309.

At S301, application interactive information is obtained and then S306 is executed.

The agent may obtain chat content information of the user and the interactive party through the social application from the user's laptop.

At S302, user input information is obtained and then S306 is executed.

The intelligent agent may obtain information input by the user in the interactive interface provided by the agent.

At S303, a scene image is captured and then S305 is executed.

The agent may take a screenshot of a currently running interface of the laptop and use the screenshot image as the scene image.

At S304, user interactive habits are obtained and then S305 is executed.

The agent may read a user information file related to the user to obtain the user's historical interactive habits.

At S305, context information is determined and then S306 is executed.

The agent may analyze the captured scene image and the user interactive habits to determine the context information related to the user input information and application interactive information, such as the current task scene.

At S306, the user task is determined and then S307 is executed.

The agent may determine the accurate user task based on the user input information, application interactive information, and context information.

At S307, retrieval is performed on the data set to obtain the retrieval results, and then S308 is executed.

Based on the determined user task, retrieval may be performed on the user's data set to obtain the retrieval results including the at least one piece of first target data.

At S308, aggregation processing is performed on the retrieval results, and then S309 is executed.

The agent may further extract information related to the user task from the retrieval results, and perform aggregation processing on the extracted information to obtain the aggregation results.

At S309, based on the aggregation results, the target processing result is generated.

After obtaining the aggregation results, the agent may use a large model to generate the target processing result that is able to be output to the user based on the aggregation processing results. For example, the output pictures may be displayed.

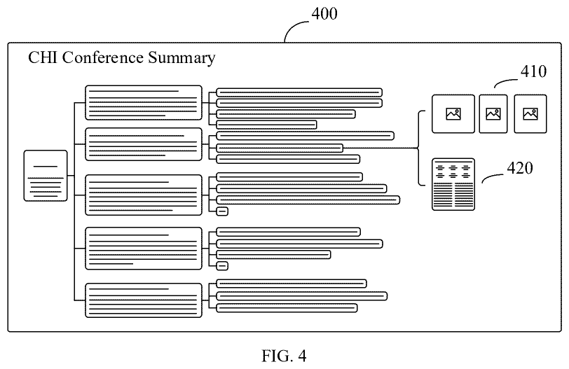

For a completed task, an output method of the corresponding target processing result may be determined based on a task scenario corresponding to the task. For example, when the task scenario corresponding to the user task is a meeting summary scenario, the target processing result may be displayed as a knowledge tree structure, where the knowledge tree includes the summary information of each topic in the meeting and the corresponding source file link, and may also include picture information related to the meeting. As shown in FIG. 4, for a summary task of a conference on computer-human interaction (CHI) technology, aggregation processing is performed based on the retrieval results of the data set to generate a corresponding knowledge tree, and links or image information about source files (for example, image 410 and paper link 420) are attached to some nodes of the knowledge tree.

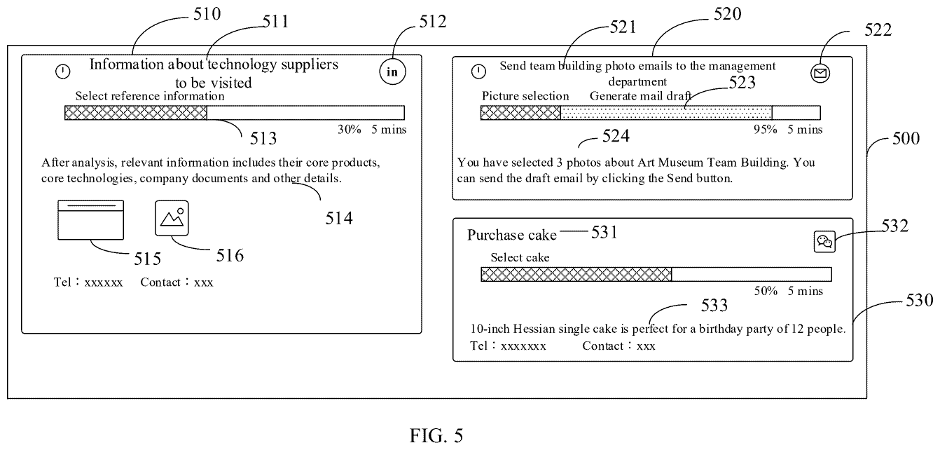

The above embodiment provides a flow chart for a user task. In some embodiments, when the agent executes one or more user tasks, the user may view the processing status of each task through a task panel provided by the agent. As shown in FIG. 5, a task panel 500 of the agent includes sub-panels 510, 520, and 530, for displaying the execution status of each task.

Each sub-panel may include corresponding task name information. For example, in FIG. 5, the task name in sub-panel 510 is “information related to the technology supplier to be visited” 511, the task name in sub-panel 520 is “send a team-building photo email to the management department” 521, and the task name in sub-panel 530 is “buy a birthday cake” 531.

Each sub-panel may use icons to indicate the corresponding task scenario information. For example, in FIG. 5, the icon 512 in sub-panel 510 indicates that the corresponding task scenario is a work scenario; the icon 522 in sub-panel 520 indicates that the corresponding task scenario is an email scenario; and the icon 532 in sub-panel 530 indicates that the corresponding task scenario is a social scenario.

Each sub-panel may also include the current execution progress information of the task.

For example, in FIG. 5, the progress bar 513 in the sub-panel 510 indicates the processing status of the current task, and the different colors of the progress bar distinguish the completed part from the unfinished part, where the grid is shaded. The shadow part indicates that the subtask “select reference information” has been completed, and the blank part indicates the unfinished part. Also, the percentage of the completed part in the entire task is indicated by a percentage, that is, 30%; and the time the task has been executed is displayed, that is, 5 minutes.

The progress bar 523 is used in the sub-panel 520 to indicate the processing status of the current task, and the different colors of the progress bar are used to distinguish the completed part from the unfinished part. The grid shadow part indicates that the subtask “picture selection” has been completed, the dotted part indicates that the “generate email draft” part has been completed, and the blank part indicates the unfinished part. Also, the percentage of the completed part in the entire task is indicated by a percentage, that is, 95%; and the time the task has been executed is displayed, that is, 5 minutes.

The progress bar 533 is used in the sub-panel 530 to indicate the processing status of the current task. The grid shadow part indicates that the subtask “select cake” has been completed, and the blank part indicates the unfinished part. Also, the percentage of the completed part in the entire task is indicated by a percentage, that is, 50%; and, the time the task has been executed is displayed, that is, 5 minutes.

Each sub-panel may also include prompt information generated by the agent, for example, in FIG. 5, prompt information 514 in the sub-panel 510, prompt information 524 in the sub-panel 520, and prompt information 534 in the sub-panel 530.

Further, task-related links or picture information may also be given in the sub-panels, for example, web page link 515 and picture 516 in the sub-panel 510, in FIG. 5.

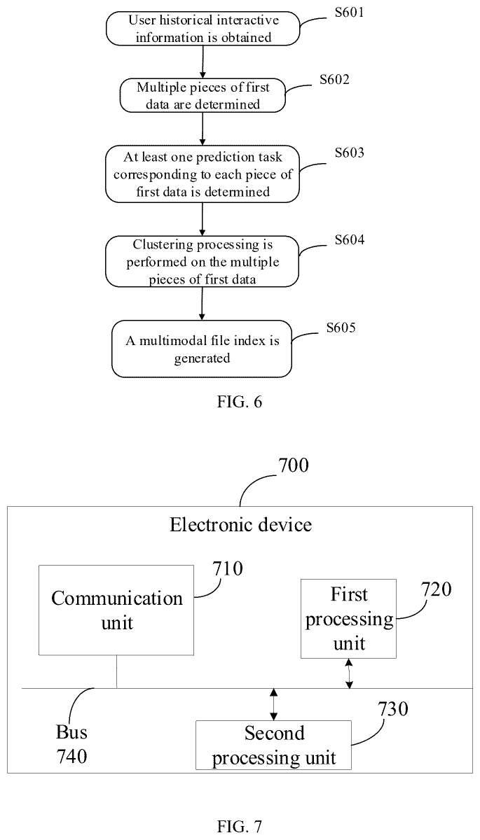

In conjunction with FIG. 6, an embodiment of generating a data set of the user using the data processing method provided by the present disclosure will be described in detail. As shown in FIG. 6, the embodiment includes S601 to S605.

At S601, user historical interactive information is obtained and then S602 is executed.

The user historical interactive information may be cross-device multimodal information related to the user.

At S602, multiple pieces of first data are determined and then S603 is executed.

The user historical interactive information may be vectorized and semantically analyzed to determine the multiple pieces of first data. For specific implementation methods, references may be made to the detailed description above.

At S603, at least one prediction task corresponding to each piece of first data is determined and then S604 is executed.

Based on the multiple pieces of first data, the at least one prediction task corresponding to each piece of first data may be predicted, and then each piece of first data may be stored in association with the corresponding at least one prediction task.

At S604, clustering processing is performed on the multiple pieces of first data and then S605 is executed.

Clustering processing may be performed on the multiple pieces of first data using a large model to achieve structured storage of the multiple pieces of first data.

At S605, a multimodal file index is generated.

Using the index generation function, based on the clustering processing results of the multiple pieces of first data, the multimodal file index information corresponding to each first data may be generated, to perform data retrieval using the multimodal file index.

The present disclosure also provides an electronic device to implement the above-mentioned data processing method. As shown in FIG. 7, in one embodiment, the electronic device 700 includes a communication unit 710 and a processor. The processor includes a first processor 720 and a second processor 730.

The communication unit 710 may be used to obtain first interactive information of the user.

The first processor 720 may be used to determine the user task based on the first interactive information using a large model.

The second processor 730 may be used to determine at least one piece of first target data from the multiple pieces of first data included in the user's data set based on the user task. The multiple pieces of first data may be determined based on the historical interactive information of cross-device multimodality related to the user, and may have corresponding prediction task information.

The first processor 720 may also be used to perform aggregation processing on the at least one piece of first target data using a large model to obtain an aggregation processing result. Based on the aggregation processing result, the target processing result corresponding to the user task may be generated.

In some embodiments, the electronic device 700 may also include a bus 740. The communication unit 710, the first processor 720 and the second processor 730 may realize data communication through the bus 740.

In some embodiments, the first interactive information may include at least one of the following: user input information determined based on the user's input operation or cross-device multimodal application interactive information related to the user.

The first processor 720 may be used to perform at least one of:
determining the user task based on the user input information; or
determining the user task based on the application interactive information.

In some embodiments, the first processor 720 may also be used to:
determine at least one piece of second target data related to the first interactive information from the multiple pieces of first data based on the first interactive information; and
determine the user task based on the first interactive information and the at least one piece of second target data.

In some embodiments, the first processor 720 may be used to:
obtain the application scenario information corresponding to the first interactive information and the historical operation information of the user;
determine the context information corresponding to the first interactive information based on the application scenario information and the historical operation information; and
determine the user task based on the context information and the first interactive information.

In some embodiments, the second processor 730 may be used to:
based on the user task, perform retrieval on the multiple pieces of first data to determine the at least one piece of first target data.

The retrieval may at least include performing retrieval on the multiple pieces of first data based on the prediction task information corresponding to the user task and each first data.

In some embodiments, the first processor 720 may also be used to:
perform semantic analysis on the historical interactive information to obtain at least one piece of first data;
based on the at least one piece of first data, predict the at least one prediction task corresponding to the at least one piece of first data, and associate the at least one prediction task with the corresponding at least one piece of first data for storage; and
perform clustering processing on the at least one piece of first data to obtain the user's data set.

In some embodiments, the first processor 720 may also be used to perform at least one of:
based on the user task and the target processing result, updating the user's data set;
in response to the user's modification operation on the target processing result, updating the target processing result; or
based on the user task and the updated target processing result, update the user's data set.

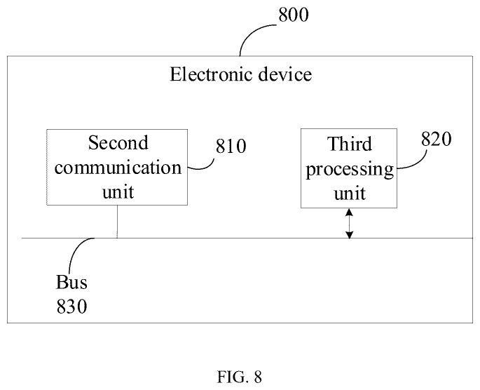

The present disclosure also provides an electronic device for executing the above data processing method. As shown in FIG. 8, in one embodiment, the electronic device 800 includes: a second communication unit 810 and a third processor 820.

The second communication unit 810 may be used to obtain the second interactive information of the cross-device multimodality related to the user.

The third processor 820 may be used to: perform semantic analysis on the second interactive information of the user to obtain at least one piece of first data; based on the at least one piece of first data, predict at least one prediction task corresponding to the at least one piece of first data; store the at least one prediction task in association with the corresponding at least one piece of first data; and perform clustering processing on the at least one piece of first data to obtain the data set of the user.

In some embodiments, the electronic device 800 may also include a bus 830, and the second communication unit 810 and the third processor 820 may realize data communication through the bus 830.

In some embodiments, the third processor 820 may also be used to perform at least one of:
based on the third interactive information of the cross-device multimodality related to the user, updating the data set; or
in response to the user's update operation on the data set, updating the data set.

The present disclosure further provides an electronic device including one or more memories storing computer-readable instructions, and one or more processors configured to execute the instructions to perform a method consistent with the disclosure, such as one of the example methods described above.

The description of the above device embodiments is similar to the description of the above method embodiments, and has similar beneficial effects as the method embodiments. In some embodiments, the functions or units included in the device provided in the embodiments of the present disclosure may be used to execute the methods described in the above method embodiments. For technical details not disclosed in the device embodiments of the present disclosure, references may be made to the description of the method embodiments of the present disclosure.

If the technical solution of the present disclosure involves personal information, the product using the technical solution of the present disclosure may clearly inform the personal information processing rules before processing personal information, and obtain the individual's voluntary consent. If the technical solution of the present disclosure involves sensitive personal information, the product using the technical solution of the present disclosure may obtain the individual's separate consent before processing sensitive personal information, and at the same time meet the “explicit consent” requirement. For example, at a personal information collection device such as a camera, a clear and obvious sign may be set to inform that the personal information collection scope has been entered and personal information will be collected. When the individual voluntarily enters the collection scope, it is deemed to agree to the collection of his or her personal information. Or, on a personal information processing device, when the personal information processing rules are notified by obvious signs/information, personal authorization is obtained by means of pop-up information or by asking the individual to upload his or her personal information. The personal information processing rules may include information such as the personal information processor, the purpose of personal information processing, the processing method, and the type of personal information processed.

It should be noted that in the embodiments of the present disclosure, if the above-mentioned data processing method is implemented in the form of a software function module and sold or used as an independent product, it may also be stored in a computer-readable storage medium. Based on this understanding, the technical solution of the embodiments of the present disclosure may be essentially or partly reflected in the form of a software product that contributes to the relevant technology. The software product may be stored in a storage medium, including several instructions to enable a computer device (which can be a personal computer, server, or network device, etc.) to execute all or part of the methods described in each embodiment of the present disclosure. The aforementioned storage medium may include: a flash disk, a mobile hard disk, a read-only memory (ROM), a hard disk or an optical disk, etc., which can store program code. Therefore, the embodiments of the present disclosure is not limited to any specific hardware, software or firmware, or any combination of hardware, software and firmware.

The present disclosure also provides a computer-readable storage medium, on which a computer program is stored. When the computer program is executed by a processor, some or all of the steps in the above methods may be implemented. The computer-readable storage medium may be transitory or non-transitory.

The present disclosure also provides a computer program, including a computer-readable code. When the computer-readable code is executed in a computer device, a processor of the computer device may execute the computer-readable code to implement some or all of the processes in the above methods.

The present disclosure also provides a computer program product, which includes a non-transitory computer-readable storage medium storing a computer program. When the computer program is read and executed by a computer, some or all of the steps in the above methods may be implemented. The computer program product can be implemented in hardware, software or a combination thereof. In some embodiments, the computer program product may be specifically embodied as a computer storage medium. In some other embodiments, the computer program product may be specifically embodied as a software product, such as a software development kit (SDK), etc.

It should be pointed out here that the description of each embodiment above tends to emphasize the differences between the embodiments, and the same or similar aspects can be referenced to each other. The description of the above device, storage medium, computer program and computer program product embodiments is similar to the description of the above method embodiments, and has similar beneficial effects as the method embodiments. For technical details not disclosed in the embodiments of the device, storage medium, computer program and computer program product of the present disclosure, references may be made to the description of the method embodiments of the present disclosure for understanding.

It should be understood that “one embodiment” or “an embodiment” mentioned throughout the specification means that the specific features, structures or characteristics related to the embodiments are included in at least one embodiment of the present disclosure. Therefore, “in one embodiment” or “in an embodiment” appearing throughout the specification does not necessarily refer to the same embodiment. In addition, these specific features, structures or characteristics can be combined in one or more embodiments in any suitable manner.

It should be understood that in various embodiments of the present disclosure, the size of the serial number of each step/process mentioned above does not mean the order of execution. The execution order of each step/process should be determined by its function and internal logic, and should not constitute any limitation on the implementation process of the embodiments of the present disclosure. The serial numbers of the embodiments of the present disclosure are only for description and do not represent the advantages or disadvantages of the embodiments.

It should be noted that in the present disclosure, the terms “include,” “comprise,” and any other variant thereof are intended to cover non-exclusive inclusion, such that a process, method, article or device including a series of elements includes not only those elements, but also includes other elements not explicitly listed, or also includes elements inherent to such process, method, article or device. In the absence of further restrictions, an element defined by the sentence “including a . . . ” does not exclude the existence of other identical elements in the process, method, article or device including the element.

It should be understood that the disclosed devices and methods can be implemented in other ways. The device embodiments described above are only schematic. For example, the division of the units is only a logical function division. There may be other division methods in actual implementation, such as: multiple units or components can be combined, or can be integrated into another system, or some features can be ignored or not executed. In addition, the coupling, direct coupling, or communication connection between the components shown or discussed can be through some interfaces, and the indirect coupling or communication connection of the device or unit can be electrical, mechanical or other forms.

The units described above as separate components may or may not be physically separated, and the components shown as units may or may not be physical units. They may be located in one place or distributed on multiple network units. Some or all of the units may be selected according to actual needs to achieve the purpose of the scheme of the present disclosure.

In addition, all functional units in the embodiments of the present application can be integrated into one processor, or each unit can be separately used as a unit, or two or more units can be integrated into one unit; the above integrated unit can be implemented in the form of hardware or in the form of hardware plus software functional units.

Those skilled in the art can understand that all or part of the steps of implementing the above method embodiments can be completed by hardware related to program instructions, and the above program can be stored in a computer-readable storage medium. When the program is executed, the steps of the above method embodiments are executed; and the above storage medium includes: a mobile storage device, a read-only memory (ROM), a disk or an optical disk, and other media that can store program codes.

Alternatively, if the above integrated unit of the present application is implemented in the form of a software functional module and sold or used as an independent product, it can also be stored in a computer-readable storage medium. Based on this understanding, the technical solution of this application, or the part that contributes to the relevant technology, can be embodied in the form of a software product. The computer software product is stored in a storage medium, including several instructions to enable a computer device (which can be a personal computer, server, or network device, etc.) to execute all or part of the methods described in each embodiment of this application. The aforementioned storage medium includes: various media that can store program codes, such as mobile storage devices, ROMs, magnetic disks or optical disks.

The above describes in detail multiple embodiments of the present disclosure, but the present disclosure is not limited to these specific embodiments. Those skilled in the art can make various variations and modifications based on the concept of the present disclosure, and these variations and modifications should fall within the scope of the present disclosure.

What is claimed is:

1. A data processing method comprising:
determining a user task based on interactive information of a user;
determining, based on the user task, at least one piece of target data from a plurality of pieces of data included in a data set of the user, the plurality pieces of data being determined based on historical cross-device multimodal historical interactive information related to the user and including prediction task information;
performing aggregation processing on the at least one piece of target data to obtain an aggregation processing result; and
generating a target processing result corresponding to the user task based on the aggregation processing result.

2. The method according to claim 1, wherein:
the interactive information includes user input information determined based on an input operation of the user; and
determining the user task based on the interactive information of the user includes determining the user task based on the user input information.

3. The method according to claim 1, wherein:
the interactive information includes cross-device multimodal application interactive information related to the user; and
determining the user task based on the interactive information of the user includes determining the user task based on the application interactive information.

4. The method according to claim 1, wherein:
the at least one piece of target data is at least one piece of first target data; and
determining the user task based on the interactive information of the user includes:
determining at least one piece of second target data related to the interactive information from the plurality of pieces of data based on the interactive information; and
determining the user task based on the interactive information and the at least one piece of second target data.

5. The method according to claim 1, wherein determining the user task based on the interactive information of the user includes:
obtaining application scenario information corresponding to the interactive information and historical operation information of the user;
determining context information corresponding to the interactive information based on the application scenario information and the historical operation information; and
determining the user task based on the context information and the interactive information.

6. The method according to claim 1, wherein determining the at least one piece of target data includes:
performing, based on the user task, retrieval on the plurality of pieces of data based on the user task and the prediction task information corresponding to each of the plurality of pieces of data, to determine the at least one piece of target data.

7. The method according to claim 1, further comprising, before determining the at least one piece of target data:
performing semantic analysis on the historical interactive information to obtain at least one piece of data;
predicting, based on the at least one piece of data, at least one prediction task corresponding to the at least one piece of data, and storing the at least one prediction task in association with corresponding data; and
performing clustering processing on the at least one piece of data to obtain the data set of the user.

8. The method according to claim 1, further comprising:
updating the data set based on the user task and the target processing result.

9. The method according to claim 1, further comprising:
in response to a modification operation on the target processing result, updating the target processing result to obtain an update target processing result and updating the data set based on the user task and the updated target processing result.

10. A non-transitory computer-readable storage medium storing instructions that, when executed by a processor, cause an electronic device including the processor to perform the method according to claim 1.

11. An electronic device comprising:
a memory storing instructions; and
a processor configured to execute the instructions to:
determine a user task based on interactive information of a user;
determine, based on the user task, at least one piece of target data from a plurality of pieces of data included in a data set of the user, the plurality pieces of data being determined based on historical cross-device multimodal historical interactive information related to the user and including prediction task information;
perform aggregation processing on the at least one piece of target data to obtain an aggregation processing result; and
generate a target processing result corresponding to the user task based on the aggregation processing result.

12. The electronic device according to claim 11, wherein:
the interactive information includes user input information determined based on an input operation of the user; and
the processor is further configured to execute the instructions to, when determining the user task based on the interactive information of the user, determine the user task based on the user input information.

13. The electronic device according to claim 11, wherein:
the interactive information includes cross-device multimodal application interactive information related to the user; and
the processor is further configured to execute the instructions to, when determining the user task based on the interactive information of the user, determine the user task based on the application interactive information.

14. The electronic device according to claim 11, wherein:
the at least one piece of target data is at least one piece of first target data; and
the processor is further configured to execute the instructions to, when determining the user task based on the interactive information of the user:
determine at least one piece of second target data related to the interactive information from the plurality of pieces of data based on the interactive information; and
determine the user task based on the interactive information and the at least one piece of second target data.

15. The electronic device according to claim 11, wherein the processor is further configured to execute the instructions to, when determining the user task based on the interactive information of the user:
obtain application scenario information corresponding to the interactive information and historical operation information of the user;
determine context information corresponding to the interactive information based on the application scenario information and the historical operation information; and
determine the user task based on the context information and the interactive information.

16. A data processing method comprising:
performing semantic analysis on interactive information of a user to obtain at least one piece of data, the interactive information representing cross-device multimodal interactive information related to the user;
predicting, based on the at least one piece of data, at least one prediction task corresponding to the at least one piece of data, and storing the at least one prediction task in association with corresponding data; and
performing clustering processing on the at least one piece of data to obtain a data set of the user.

17. The method according to claim 16, further comprising:
updating the data set based on other cross-device multimodal interactive information related to the user.

18. The method according to claim 16, further comprising:
updating the data set in response to an update operation on the data set.

19. An electronic device comprising:
a memory storing instructions; and
a processor configured to execute the instructions to perform the method of claim 16.

20. A non-transitory computer-readable storage medium storing instructions that, when executed by a processor, cause an electronic device including the processor to perform the method according to claim 16.
